(19) United States
(12) Patent Application Publication
(10) Pub. No.: US 2002/0014370 A1
(43) Pub. Date: Feb. 7, 2002

(54) Fall arrest methods and apparatus with u-joint connector

(76) Inventors: Scott C. Casebolt, St. Paul Park, MN (US); John D. Jorgensen, Brooklyn Center, MN (US)

Correspondence Address: Mau & Krull, P.A., Suite E, 1250 Moore Lake Drive East, Fridley, MN, 55432, US

(21) Appl. No.: 09/833,093

(22) Filed: Apr. 11, 2001

Related U.S. Application Data
(60) Provisional application No. 60/197,467, filed on Apr. 17, 2000.

(51) Int. Cl. A62B 1/16

(52) U.S. Cl. 182/5; 182/8

(57) ABSTRACT

A fall arrest device includes a housing, a braking assembly, and a coupling assembly. The braking assembly cooperates with an elongate support to facilitate controlled movement of the fall arrest device along the elongate support. The coupling assembly is interconnected between the housing and a person to be supported by the device in the event of a fall. The coupling assembly includes a universal joint to accommodate various connection arrangements between the fall arrest device and the person.

### FIELD OF THE INVENTION

The present invention relates to fall arrest methods and apparatus and more specifically, to a universal joint interconnected between a fall arrest device and a person to be supported by the device in the event of a fall.

### BACKGROUND OF THE INVENTION

Many different devices and systems are known and used for purposes of arresting a person's fall. Generally speaking, people who work at dangerous heights connect themselves or “tie off” to a proximate support structure. In the event of a mishap, a person's fall is arrested by the device or devices interconnected between the person and the support structure. One of many known safety devices is disclosed in U.S. Pat. No. 5,265,696 to Casebolt. The Casebolt device may be described as a ladder climbing safety clamp or cable grab, which is selectively movable up and down a cable disposed alongside a ladder. The clamp generally includes a brake assembly which is mounted on the cable, and an arm which is connected to a person intending to climb up or down the ladder. The clamp is designed to grab the cable if the person falls from the ladder. An object of the present invention is to form an improved link between a person and the Casebolt device or any other suitable fall-arrest device.

### SUMMARY OF THE INVENTION

The present invention provides methods and apparatus which facilitate a convenient and effective interconnection between a person and a fall-arrest device. On a preferred embodiment and/or in a preferred mode of operation, a connector with a universal joint is mounted on a fall arrest device and selectively connected to a person. The universal joint accommodates various connection angles and reduces the likelihood that any intervening members and/or lanyards will become tangled or twisted about themselves and/or the safety device. Additional features and/or advantages of the present invention may become more apparent from the detailed description which follows.

### BRIEF DESCRIPTION OF THE DRAWING

With reference to the Figures of the Drawing, wherein like numerals represent like parts and assemblies throughout the several views,

FIG. 1 is a side view of a safety device having a preferred embodiment connector constructed according to the principles of the present invention;

FIG. 2 is a top view of the safety device and connector of FIG. 1; and

FIG. 3 is a side view of the safety device and connector of FIG. 1 interconnected in series between a person and a support structure.

### DETAILED DESCRIPTION OF THE PREFERRED EMBODIMENT

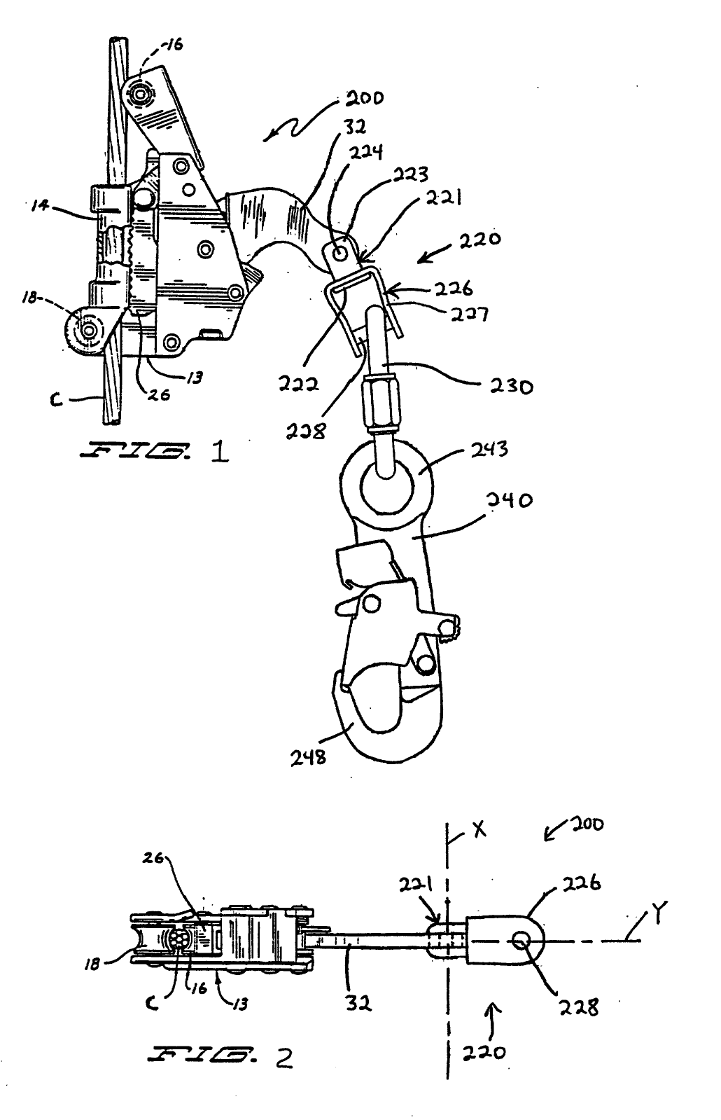

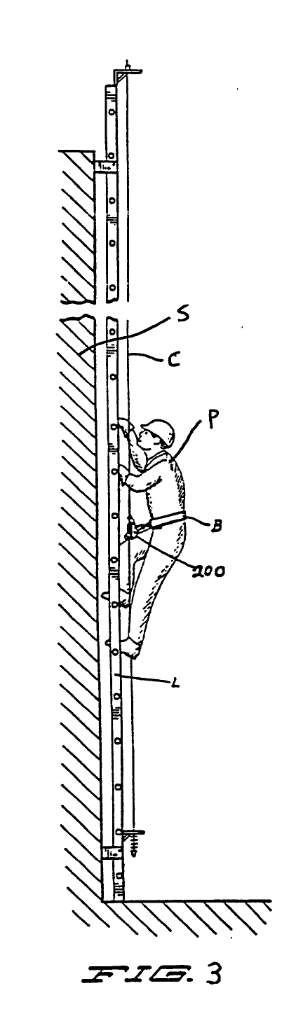

A preferred embodiment connector constructed according to the principles of the present invention is designated as 220 in FIGS. 1-2. In a preferred mode of operation, the connector 220 is mounted on a preferred embodiment safety device 200, and the safety device 200 is interconnected in series between a person P and a support structure S. With the exception of the connector 220, the safety device 200 is identical to the device disclosed in U.S. Pat. No. 5,265,696 to Casebolt, which is incorporated herein by reference. Those skilled in the art will recognize that the present invention is not necessarily limited to this particular safety device 220, nor to this particular type of fall-arrest system.

As noted in the Casebolt patent, the device 200 includes a housing 13 having a cable sleeve 14 sized and configured to receive a cable C. Generally speaking, a lever arm 32 is movably mounted on the housing 13 and linked to a brake shoe 26 disposed adjacent the cable C. A distal end of the arm 32 is provided with an opening (designated as 34 in the Casebolt patent) to support the connector 220 of the present invention, which in turn, is connected to a belt B or other safety garment worn by a person P working at a dangerous height. Under normal operating conditions, as the person P ascends or descends ladder L, the cable C readily passes through the sleeve 14, guided by rollers 16 and 18. In the event of a fall, the brake shoe 26 is forced against the cable C to resist downward movement of the device 200 relative to the cable C.

The connector 220 includes a first member or intermediate member 221 and a second member or anchorage member 226. The first member 221 includes a flat, circular head 222, and two flanges 223 which extend perpendicularly away from the head 222 and define a gap therebetween. The flanges 223 are bounded by a cylinder which is concentrically nested relative to the circumference of the head 222. A hole extends transversely through the flanges 223 to receive a pin 224. The pin 224 extends through the hole in the distal end of the arm 32, and each end of the pin 224 is affixed to a respective flange 223. As a result of this arrangement, the first member 221 is rotatably mounted on the arm 32 and cooperates therewith to define a rotational axis X.

The second member 226 includes a U-shaped bracket 227 and a shaft 228 secured between opposing distal ends of the bracket 227. A hole extends through the base of the bracket 227. The hole is sized and configured to admit passage of the flanges 223 (prior to their connection to the arm 32) but not the head 222. Upon fastening of the flanges 223 to the arm 32, the second member 226 is rotatably mounted on the first member 221 and cooperates therewith to define a rotational axis Y. The resulting arrangement may be described as a universal joint having two degrees of rotational freedom (about the perpendicular axes X and Y).

A carabiner or other suitable fastener 230 may be secured about both the shaft 228 and a ring portion 243 of a safety hook or other suitable fastener 240, to facilitate connection to the person's belt B or other known safety apparel. Those skilled in the art will recognize that other secondary connections may be made without departing from the scope of the present invention. For example, the ring portion 243 of the safety hook 240 may be secured to the person's belt B, and the hook portion 248 of the safety hook 240 may be releasably secured about the shaft 228. In either case, a lanyard may also be secured in series between the person P and the device 200. In any event, the universal joint accommodates connection at any angle, as well as unencumbered movement of the component(s) interconnected between the device 200 and the person's belt B.

In the absence of a universal joint, the intervening component(s) are more likely to become twisted and/or tangled as the person moves about. By making the safety device 200 relatively more convenient to use, the present invention provides one less distraction for people working at heights and also increases the likelihood that safety devices will be used properly and at all times. For example, during the use of prior art equipment, the intervening component(s) become twisted and/or tangled and thereby impair a person's ability to move, so the person may be tempted to temporarily disconnect from the safety device in order to remove the twists and/or tangles.

Although the present invention has been described with reference to a preferred embodiment and a particular application, those skilled in the art will recognize additional embodiments and/or applications. Thus, the scope of the present invention should be limited only to the extent of the following claims.

What is claimed is:

1. A fall arrest device of the type having a housing, a braking assembly connected to the housing and operable to travel along an elongate support under normal operating conditions and to resist movement along the elongate support if a fall occurs, the improvement comprising:
an arm having a first end connected to the housing, and a second, distal end; and
an anchorage member connected to the distal end of the arm by a universal joint.

2. The fall arrest device of claim 1, wherein an intermediate member is mounted on the distal end of the lever and rotatable about a first axis relative thereto, and the anchorage member is mounted on the intermediate member and rotatable about a second axis relative thereto, and the second axis extends perpendicular to the first axis.

3. The fall arrest device of claim 2, wherein the distal end of the lever is disposed between opposing portions of the intermediate member, and a pin extends through a hole in the distal end of the lever, and opposite ends of the pin are secured to respective opposing portions of the intermediate member.

4. The fall arrest device of claim 3, wherein the opposing portions of the intermediate member are secured to a common head portion which is diametrically larger than the opposing portions, as measured parallel to the second axis.

5. The fall arrest device of claim 4, wherein the opposing portions of the intermediate member extend through a hole in the anchorage member in such a manner that the distal end of the lever and the head portion of the intermediate member are disposed on opposite sides of the anchorage member.

6. The fall arrest device of claim 5, wherein the anchorage member includes a U-shaped bracket and a shaft, and the hole in the anchorage member extends through a base portion of the bracket, and opposing side portions of the bracket extend perpendicularly away from the base portion, and the shaft has opposite ends secured to respective opposing side portions.

7. A fall arrest device of the type that travels along an elongate support under normal operating conditions and resists movement along the elongate support if a fall occurs, the improvement comprising a universal joint which terminates in an anchorage member.

8. The fall arrest device of claim 7, wherein the universal joint is formed by an intermediate member which rotates about a first axis relative to a discrete portion of the device, and cooperates with the anchorage member to define a second axis of rotation which extends perpendicular to the first axis.

9. The fall arrest device of claim 8, wherein the intermediate member has opposing portions disposed about the discrete portion of the device, and a pin extends through a hole in the discrete portion, and opposite ends of the pin are secured to respective opposing portions of the intermediate member.

10. The fall arrest device of claim 9, wherein the opposing portions of the intermediate member are secured to a common head portion which is diametrically larger than the opposing portions, as measured parallel to the second axis.

11. The fall arrest device of claim 10, wherein the opposing portions of the intermediate member extend through a hole in the anchorage member in such a manner that the discrete portion of the device and the head portion of the intermediate member are disposed on opposite sides of the anchorage member.

12. The fall arrest device of claim 11, wherein the anchorage member includes a U-shaped bracket and a shaft, and the hole in the anchorage member extends through a base portion of the bracket, and opposing side portions of the bracket extend perpendicularly away from the base portion, and the shaft has opposite ends secured to respective opposing side portions.

13. A method of forming a connection between a fall arrest device and a person's body, comprising the steps of:
providing a fall arrest garment with an anchorage;
securing the fall arrest garment to the person's body;
providing a fall arrest device with an anchorage supported by a universal joint;
connecting the fall arrest device to a support structure; and
connecting the anchorage on the fall arrest device to the anchorage on the garment.
